(19) United States
(12) Patent Application Publication
(10) Pub. No.: US 2023/0212777 A1
(43) Pub. Date: Jul. 6, 2023

(54) SYSTEMS AND METHODS FOR REGULATING HYDROGEN TRANSPORT OUT OF STRUCTURAL MATERIALS

(71) Applicant: MASSACHUSETTS INSTITUTE OF TECHNOLOGY, Cambridge, MA (US)

(72) Inventors: Ju LI, Weston, MA (US); Bilge YILDIZ, Cambridge, MA (US); Cemal Cem TASAN, Cambridge, MA (US); Jinwoo KIM, Revere, MA (US); Xiahui YAO, San Jose, CA (US)

(21) Appl. No.: 18/009,587

(22) PCT Filed: Jul. 29, 2021
(86) PCT No.: PCT/US2021/043707

§ 371 Date: Dec. 9, 2022

Related U.S. Application Data
(60) Provisional application No. 63/058,403, filed on Jul. 29, 2020.

(51) Int. Cl. C25F 3/06; C25F 7/00

(52) U.S. Cl. CPC C25F 3/06; C25F 7/00

(57) ABSTRACT

Systems and methods for regulating hydrogen concentration in structural materials by electrochemically controlling hydrogen desorption to promote recovery from hydrogen embrittlement are disclosed. Embrittled material can be exposed to an electrolyte and a counter electrode to set up a potential across the material to induce the electrochemical oxidation of atomic hydrogen (H) in the surface of the material. Oxidation reduces hydrogen concentration near the surface, increases hydrogen diffusion toward the surface, and eventually accelerates hydrogen desorption through and out of the material. In some embodiments, a catalyst can be applied to the surface of the material to return the material to its original state before embrittlement.

### CROSS REFERENCE TO RELATED APPLICATION

The present disclosure claims priority to and the benefit of U.S. Provisional Application No. 63/058,403, entitled “Systems and Methods for Regulating Hydrogen Transport out of Structural Materials,” filed on Jul. 29, 2020, and which is incorporated by reference herein in its entirety.

### FIELD

The present disclosure relates to regulating hydrogen concentration in structural materials, and more particularly relates to controlling hydrogen desorption to recover the structural materials from hydrogen embrittlement.

### BACKGROUND

Materials such as structural metals have been used in a variety of manufacturing, testing, and development processes over the last century to create the products that are used every day. Over time, as production needs and accompanying costs have increased, manufacturers began to search for ways to prolong the life of the machinery involved in manufacturing such that downtime can be minimized and existing parts can be used for a larger number of cycles. One such way of prolonging the life of parts was found to minimize the number of foreign elements and particulates, e.g., hydrogen, oxygen, carbon, and so forth, that the structural metals absorbed, and, in the event that absorbance took place, allow the metals to recover or heal from said absorbance.

Regulating hydrogen transport in structural metals has been shown to prevent hydrogen embrittlement, with hydrogen transport in such metals being classified as: (1) hydrogen ingress; (2) internal diffusion and trapping; and (3) desorption. Industries that utilize hydrogen-containing resources contacting metallic structural materials include energy industries such as natural gas pipelines and thermoelectric or nuclear power plants, automotive industries that produce advanced automotive steel and hydrogen powered cases, and/or marine industries that service offshore plans and utilize vessel steels. Conventional processes for regulating hydrogen intake or transport from materials have focused on hydrogen ingress by introducing chemical inhibitors or physical barrier coatings to block hydrogen ingress, and internal diffusion and trapping by introducing alloy carbides that act as strong trapping sites. These conventional processes have achieved their intended purposes with varying degrees of success.

Controlling hydrogen desorption, or hydrogen removal to heal materials from embrittlement, however, has not been pursued due to several technical difficulties. First, while thermal treatment can be a way to remove internal hydrogen, it has a practical difficulty that requires disassembly of parts out of an in-service state. Shutdown, disassembly, and replacement of parts can increase downtime of the system, which can increase costs and lead to less product being produced. Further, thermal treatment to remove hydrogen has been shown to substantially decrease the strength of the materials from which the hydrogen was recovered.

Accordingly, there is a need for systems, devices, and methods that can control hydrogen desorption to prevent and/or rapidly heal structural materials from hydrogen embrittlement.

### SUMMARY

The present application is directed to systems and methods for regulating an amount of hydrogen within a structural material. The use of these systems and methods to accelerate hydrogen removal from materials is one exemplary type of protection of metals, such as steel, titanium, iron, or stainless steel, but as provided for herein, more broadly can be used to protect any parts and/or many materials from hydrogen embrittlement. For example, the instantly disclosed systems and methods can be applied to plastics, such as polyurethanes, glass, ceramics, and so forth to protect the underlying material from hydrogen permeation.

The systems and methods disclosed herein have a wide variety of potential applications. These include, by way of non-limiting examples, use in natural gas pipelines and power plants, manufacture of advanced automotive steels and hydrogen-powered cars, and structural support of offshore plants and vessel steels.

Controlling hydrogen desorption allows for regulation of the rate at which materials recover and/or heal from hydrogen embrittlement. Hydrogen embrittlement is seen as a critical industrial problem as embrittlement can cause significant deterioration in mechanical properties of metals, which are particularly vulnerable to such damage. The systems, devices, and processes disclosed herein provide for electrochemical hydrogen pumping that utilize steps of exposing a material to an electrolyte, depositing a catalyst on the material, disposing a counter electrode within the electrolyte, and applying a potential between the material and the counter electrode. Applying a positive electrical potential (or current) to the working electrode induces the electrochemical oxidation of atomic hydrogen (H) in the working electrode at its surface. The potential creates a gradient across the material to accelerate diffusion of the hydrogen to a surface of the material to promote an oxidation reaction of the atomic hydrogen contained within the material. As described herein, various parameters associated with the electrolyte, the catalyst, the electrode, and the processing steps can be adjusted to produce desirable results for desorption of hydrogen that is controlled via the disclosed processes.

In one exemplary embodiment of a method of regulating hydrogen transport from a material, the method includes exposing a material to an electrolyte, the material being in an embrittled state from an original state due to a concentration of atomic hydrogen contained therein, depositing a catalyst onto the material, disposing a counter electrode in the electrolyte, and applying a potential between the material and the counter electrode. The potential creates a gradient across the material to accelerate diffusion of the hydrogen to a surface of the material by promoting an oxidation reaction of the atomic hydrogen contained within the material.

The method can further include adjusting the potential accelerates a rate of atomic hydrogen oxidation to hydrogen ion. For example, the applied potential can be approximately in a range from about 0 V to about +100 V versus reversible hydrogen electrode potential. In some embodiments, the applied potential can be lower than a passivation threshold potential of the material. The oxidation reaction can occur at room temperature. In some embodiments, the method can further include adjusting the potential to change a rate of diffusion of the hydrogen to the surface of the material.

The material can be one of steel and stainless steel. The catalyst can include one or more of palladium, platinum, nickel, titanium, molybdenum disulfide or lanthanum. The catalyst can be applied onto a surface of the material while the material is immersed in the electrolyte to bring the hydrogen to the surface of the material. The material can recover to substantially over 90% of ultimate tensile strength and fracture strain as hydrogen diffuses towards the surface thereof. The diffusion of hydrogen can occur either without thermal treatment or with heating of up to 200° C. The oxidation reaction reduces the concentration of the hydrogen contained in the material.

In one exemplary embodiment of a system for recovering materials from hydrogen embrittlement, the system includes an electrolyte, a material having atomic hydrogen therein, the material being disposed in the electrolyte, a catalyst applied to the surface of the material, and an electrode disposed in the electrolyte, the electrode being in communication with the material, with the electrode being configured to apply a potential across the material that creates a gradient across the material to accelerate diffusion of the hydrogen to a surface of the material, thereby promoting an oxidation reaction of the atomic hydrogen contained within the material.

The catalyst includes one or more of palladium, platinum, nickel, titanium, molybdenum disulfide or lanthanum. The electrode includes one or more of platinum, palladium, nickel, titanium, molybdenum or their alloys. The material can be one or more of iron, nickel, cobalt, aluminum, magnesium, titanium, zirconium, steel, stainless steel, alloys thereof, or superalloys thereof.

In some embodiments, the system can be configured to operate either without the use of thermal treatment or with heating of up to 200° C. The system can be configured to operate either without the use of thermal treatment or with heating of up to 200° C.

### BRIEF DESCRIPTION OF THE DRAWINGS

This disclosure will be more fully understood from the following detailed description taken in conjunction with the accompanying drawings, in which:

FIG. 1 is a schematic illustration of an exemplary embodiment of an electrochemical hydrogen pumping system used within the scope of the present disclosure;

FIG. 2A is a graph illustrating a degree of recovery of hydrogen charged and uncharged metals by pumping potential of +0.3 V versus Hg/HgO electrode applied to said metals;

FIG. 2B is a graph illustrating a degree of recovery of hydrogen charged and uncharged metals by pumping potential of +0.6 V versus Hg/HgO electrode applied to said metals;

FIG. 2C is a graph illustrating recovery of 430 ferritic stainless steel from hydrogen embrittlement by uncontrolled H-desorption in air in ambient conditions;

FIG. 3 is a graph illustrating fractions of recovery from hydrogen embrittlement that depends on methods and time used;

FIG. 4 is a schematic illustration of another exemplary embodiment of an electrochemical hydrogen pumping system having a working electrode and a counter electrode disposed in electrolyte with a catalyst being applied to the working electrode;

FIG. 5 is a graph illustrating hydrogen pumping current density of a martensitic stainless steel with and without catalyst;

FIG. 6A is a graph illustrating tensile test results of martensitic stainless steel sheets after hydrogen charging for five minutes and recovery using an electrochemical hydrogen pumping system; and

FIG. 6B is a graph illustrating fractions of recovery of a martensitic stainless steel from hydrogen embrittlement depending on the amount of hydrogen charging time and recovery time used.

### GENERAL DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, compositions, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

To the extent that the instant disclosure includes various terms for components and/or processes of the disclosed systems, methods, and the like, one skilled in the art, in view of the claims, present disclosure, and knowledge of the skilled person, will understand such terms are merely examples of such components and/or processes, and other components, designs, processes, and/or actions are possible. By way of non-limiting example, the hydrogen embrittled material can be described as a working electrode for the purposes of electrochemical desorption of hydrogen therefrom. A person skilled in the art, however, in view of the present disclosures, will understand other ways by which hydrogen can be removed from the material such as by hydrogen desorption, electrochemical pumping and so forth.

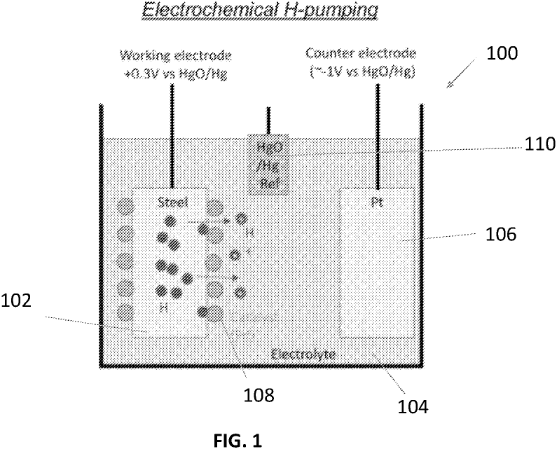

The present disclosure generally relates to recovering materials, e.g., steels and other metals, from hydrogen embrittlement by accelerated electrochemical desorption or pumping of hydrogen to remove hydrogen contained therein. FIG. 1 illustrates an exemplary embodiment of an electrochemical hydrogen pumping configuration 100 within the scope of the present disclosure. As shown, the electrochemical configuration 100 includes one or more of a working electrode 102 (e.g., hydrogen-embrittled metal), electrolyte 104, and counter electrode 106 (e.g., platinum). Applying a positive electrical potential (or current) to the working electrode 102 induces the electrochemical oxidation of atomic hydrogen (H) in the working electrode 102 at its surface. Oxidation of atomic hydrogen in the working electrode 102 reduces hydrogen concentration near the surface of the electrode, thereby creating a gradient across the electrode 102. The gradient can increase hydrogen diffusion toward the surface in the working electrode, and eventually accelerates hydrogen desorption from the working electrode 102.

In some embodiments, the electrochemical desorption can occur at or near room temperature. By removing hydrogen near room temperature, the mechanical properties of the working electrode can be recovered to its original state, or near original state, which refers to recovery over 90% of ultimate tensile strength and fracture strain before embrittlement. By comparing the mechanical behavior of H-precharged specimens after uncontrolled desorption and controlled electrochemical desorption experiments, the systems and methods of the present disclosure showed substantial, and in some cases, complete recovery of commercial steels from hydrogen embrittlement. It will be appreciated that, in at least some embodiments, desorption can occur at temperatures that are hotter or colder than room temperature.

Either separately, or as part of an overall manufacturing process, the material can be made from a structural metal (e.g., iron, nickel, cobalt, aluminum, magnesium, titanium, zirconium, steel, stainless steel, alloys thereof, or superalloys thereof, and so forth, including combinations thereof) in which deterioration and/or embrittlement of materials is undesirable at least because the presence of hydrogen can make the material prone to fracture in a brittle way due to hydrogen ingress. By way of non-limiting example, such materials can include, or make up a substantial part of, a variety of objects across a variety of industries, such as: a shell of an airplane (i.e., the combination of the fuselage, wings, and horizontal and vertical stabilizers); the housings, exteriors, and/or related components of other modes of transportation; advanced automotive steels (e.g., head and tail lights of a vehicle or other mode of transportation); hydrogen-powered cars; offshore plants and vessel steels; factory equipment, such as natural gas pipelines, thermoelectric and/or nuclear power plants, pipes, and heat exchangers. A person skilled in the art will appreciate many more objects and industries to which the present disclosures can be applied to prevent the deterioration and/or embrittlement of one or more materials used to make one or more objects.

The electrochemical processes disclosed herein can be performed by using a system having one or more compounds that remove the hydrogen from the system. One exemplary embodiment of the electrochemical configuration can include one or more of: (i) a H-embrittled material; (ii) proton-conductor (electrolyte); and (iii) counter electrode, with the system being configured to remove the hydrogen from the H-embrittled material. The hydrogen embrittlement can cause the material to transform from its original state, or undeformed state, into a vulnerable state, e.g., a state that it is more prone to crack and/or fracture (exhibiting a reduced fracture strain and fracture toughness, as compared to the original state, when it is tested by a mechanical testing method such as tensile test, compression test, impact test, fracture toughness test and so forth). It will be appreciated that the material in its original state resembles a material that has not undergone hydrogen embrittlement, or not undergone substantial hydrogen embrittlement, while a material in its H-embrittled state, or a vulnerable state, has a reduction of fracture strain of approximately 10% or more from that of its original state such that it is more prone to crack and/or fracture. Moreover, recovery to an original state can be considered to be a material that has an increase of fracture strain of approximately 10% or more from that of its H-embrittled state such that it is less prone to crack and/or fracture.

In some embodiments, the material can have a catalyst 108 applied onto a surface thereof. A person skilled in the art will recognize that each of the catalyst 108, electrolyte 104, and counter electrode 106 can be used alone or in combination to achieve an optimized recovery of the material. It will also be appreciated that additional materials and parameters of the present systems and methods can be tuned such that recovery of the material from hydrogen embrittlement is optimized, as discussed in greater detail below.

As shown, the electrochemical recovery can be done both by using both a liquid proton conducting electrolyte and/or a solid proton conducting electrolyte, broadly. For example, the potential spectrum of liquid electrolytes in a wet-process can include a diluted NaOH solution, while solid electrolytes in a dry-process can include polymer-based electrolytes such as Nafion, or all inorganic solid proton conductors such as doped BaZrO₃ compounds, for example BaZr_{0.1}Ce_{0.7}Y_{0.2}O_{3-δ}, or aliovalently doped CeO₂, and solid acid proton conductors such as CsHSO₄. The wet-process can be applied to a field where hydrogen embrittlement in an aqueous environment is a concern, such as reactor pressure vessels, naval applications and pipelines and components in oil-gas explorations, while the dry-process can be applied to a wide range of metallic components that are exposed to hydrogen gas environments in hydrogen distribution, storage and dispensing applications. In addition to the electrolytes discussed herein, some non-limiting examples of electrolytes contemplated to be used with the present disclosure can include neutral or acidic liquid electrolyte compromised by water and salt, such as NaCl, Na₂SO₄ solution, and organic liquid electrolyte compromising protonic solvents and ionic liquid electrolyte, such as acetonitrile, alcohol solution and 1-Ethyl-3-methylimidazolium trifluoromethanesulfonate, and polymeric solid proton electrolyte, such as polybenzimidazole.

The counter electrode 106 can include a material that can create a potential across the electrolyte with the material. Some non-limiting examples of the counter electrode 106 can include platinum, palladium, nickel, titanium, molybdenum and their alloys, as well as combinations thereof. A person skilled in the art will recognize that the system can include a reference electrode 110 within the electrolyte 104, e.g., an HgO/Hg electrode, for instance to help calculate the potential created between the material and the counter electrode 106.

Electrochemical pumping can accelerate the desorption of hydrogen from the material 102. For example, electrochemical pumping can create an oxidative environment on the surface of the material 102. The catalyst can be applied onto the surface of the material 102 to facilitate creation of low hydrogen concentration thereon, and a low equivalent p(H2) near the surface. In some embodiments, the catalyst can promote atomic hydrogen oxidation to H⁺ and protect the surface of the material 102 from oxide formation that blocks hydrogen from being extracted. As pumping continues, a concentration gradient can be created across the material 102 such that hydrogen flows out of the material 102 towards the surface of the material 102 and, eventually, out of the material 102. Some non-limiting examples of the catalyst 108 can include palladium, platinum, nickel, titanium, molybdenum disulfide and lanthanum, as well as combinations thereof. While the presently disclosed methods can be performed in the absence of a catalyst, the presence of the catalyst 108 can increase the gradient across the material 102 to increase flow of hydrogen out of the material 102, thus increasing the efficiency with which the material 102 is recovered from hydrogen embrittlement.

In use, electrochemical pumping occurs by applying a potential between the material 102 and the counter electrode 106, as discussed above. The potential can accelerate the diffusion of hydrogen through the material 102 and into the electrolyte. The potential to extract hydrogen from the H-embrittled material can be a positive value, approximately in a range between 0 to about +100 V or more, versus reversible hydrogen electrode potential, though in some embodiments, the range can be between 0 and +50 V, between 0 and +25 V, between 0 and +10 V, between 0 and +5 V, or between 0 and +2 V. For example, cyclic voltammetry can be used to measure hydrogen reduction and oxidation of the material having a catalyst thereon. In the case of palladium coated steel, when a HgO/Hg electrode is used as a reference electrode, a H-extraction potential of approximately +0.3 V vs HgO/Hg can be used, while induction of steel corrosion is minimized. A person skilled in the art will appreciate that the values of the applied potential can depend, at least in part, on one or more of the material(s) of the working electrode, counter electrode, electrolyte, and/or catalyst and the desired outcome, among other factors. For example, when polymeric electrolyte with higher ionic resistance is used, compensation of iR loss need to be factored in and compensated to increase the applied potential. When counter electrode is not kinetically favored, additional overpotential needs to be factored in and compensated for to increase the applied potential. Moreover, if two-electrode mode is adopted instead of three-electrode, when the counter electrode is carrying other chemical reactions other than hydrogen evolution reactions, a different potential between the working electrode 102 and counter electrode 106 is used as the base voltage.

A person skilled in the art will recognize that the applied potential can vary based on the electrolyte used. For example, for solid, stable, or non-corrosive electrolytes, the applied potential range can be high, e.g., approximately in a range between 0 to about +100 V or higher. In some embodiments, e.g., when a liquid electrolyte or a corrosive, or non-stable electrolyte is used, the applied potential can be kept below a passivation threshold potential, such that hydrogen can be extracted from the material while a passivation layer remains on the surface thereof to avoid corrosion or insufficient levels of hydrogen oxidation. It will be appreciated that a value for the passivation threshold potential can vary based on one or more of the material, type of electrolyte used, and so forth.

Likewise, it will be appreciated by a person skilled in the art that the pumping conditions can vary based, for instance, on the type of materials being used. For example, when a milder electrolyte, e.g., a neutral electrolyte such as sodium sulphate solution (0.1 M), is used, parameters such as temperature and pressure can be increased and/or decreased to optimize recovery of the material from hydrogen embrittlement. Moreover, in some embodiments, use of an acidic electrolyte can cause unwanted corrosion, and use of the milder electrolyte with higher potential can yield better recovery results.

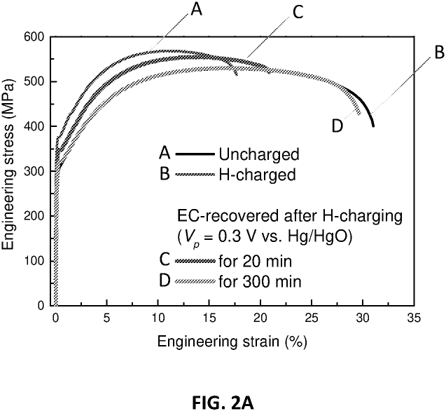

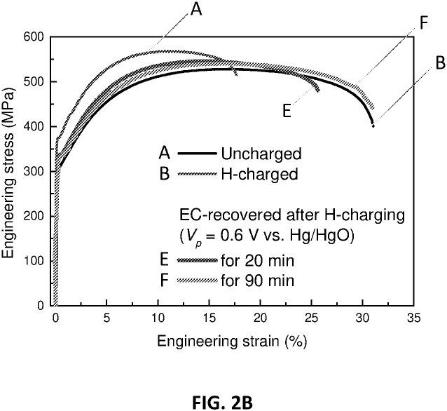

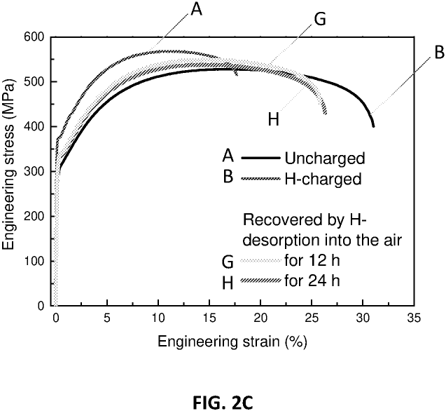

In some embodiments, the potential can be adjusted to accelerate a rate of atomic hydrogen oxidation to hydrogen ion. That is, increasing the potential can accelerate the time taken to reach substantially full recovery of the material. For example, FIGS. 2A-2C illustrate the impact of adjustments on the degree of recovery of materials, e.g., ferritic stainless steel, from hydrogen embrittlement by changing various factors such as increasing the potential, pumping, and/or adding a catalyst.

In some embodiments, such as in ferritic stainless steel materials described above, combining a catalyst and pumping can allow for recovery to improve, as compared to an uncharged material, while the system is maintained at a lower potential, e.g., approximately +0.3 V. For example, FIG. 2A illustrates relative behavior of engineering stress and strain for various samples of ferritic stainless steel. As shown, recovery data for a set of hydrogen charged samples (A) is compared to a set of uncharged samples (B). When compared, the hydrogen charged samples (A) have approximately 43% decreased fracture strain as compared to the uncharged samples (B) due to hydrogen embrittlement. The effect of electrochemical pumping to recover the samples from hydrogen embrittlement, with a potential to +0.3 V, is illustrated in sample (C), for which electrochemical pumping is performed for 20 minutes, and sample (D) for which electrochemical pumping is performed for 300 minutes. As shown, the recovery of the material when electrochemical pumping is performed for 300 minutes closely resembles that of the uncharged material and significantly outperforms recovery of the material exposed to pumping for 20 minutes.

FIG. 2B illustrates the impact of raising the potential in the material to approximately +0.6 V can increase the rate at which the catalyst undergoes atomic hydrogen oxidation to hydrogen ion, thereby increasing the gradient across the material. An increased gradient can increase the diffusion of hydrogen across the material such that hydrogen is pumped out of the material at a faster rate. The increased rate of the hydrogen leaving that material allows the material to recover in a fraction of the time as compared to recovery experienced in the absence of pumping. As shown in FIG. 2B, raising the potential in the material to approximately +0.6 V with electrochemical pumping can lead to substantial recovery of the material in 20 minutes (E), as compared to materials exposed to electrochemical pumping at a potential of approximately +0.3 V in the same time length (C in FIG. 2A), and/or a recovery time of approximately 12 to 24 hours by uncontrolled H-desorption at ambient conditions without electrochemical pumping (FIG. 2C). Electrochemical pumping with +0.6 V can lead to substantially complete recovery of the material in 90 minutes (F). In some embodiments, complete recovery of the material via electrochemical pumping can occur in less than about 1 hour, less than about 30 minutes, and/or less than about 20 minutes. It will be appreciated that substantially complete recovery from hydrogen embrittlement can encompass a recovery of ultimate tensile strength and fracture strain to 90% of the original state.

FIG. 2C illustrates recovery of 430 ferritic stainless steel from hydrogen embrittlement by uncontrolled H-desorption in air in ambient conditions. The degree of recovery by the uncontrolled desorption for 12 hours (G) resembles that of electrochemical pumping with +0.6 V for 20 minutes (E in FIG. 2B), which shows the superior recovery efficiency of electrochemical pumping. The uncontrolled desorption for an extra 12 hours, total 24 hours (H), yields negligible differences, which represent the limitation of recovery by uncontrolled desorption that it is difficult to achieve complete recovery by the uncontrolled desorption.

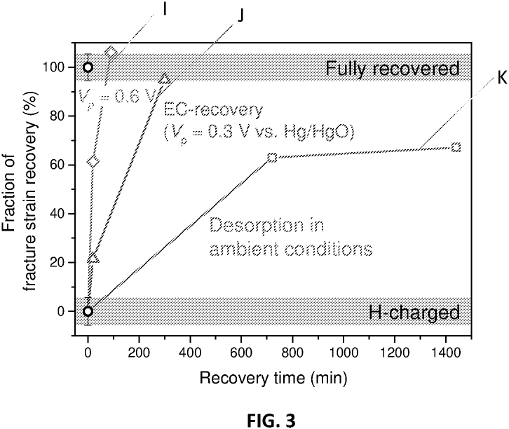

FIG. 3 illustrates fractions of recovery from hydrogen embrittlement that depends on methods and time. As shown, the increased potential curve (I) discussed above (+0.6 V) exhibits the quickest recovery rate as compared to electrochemical recovery with +0.3 V (J). The uncontrolled desorption in air (K), meanwhile, plateaus and never reaches full recovery from hydrogen embrittlement, further suggesting that electrochemical recovery using the processes discussed in the present disclosure produces superior results as compared to conventional methods.

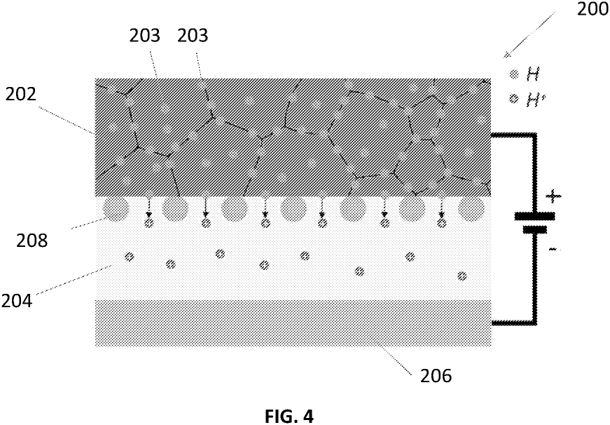

As discussed above, addition of a catalyst, e.g., a palladium catalyst, can increase hydrogen pumping efficiency to promote greater recovery from hydrogen embrittlement in ferritic stainless steel. FIG. 4 illustrates a schematic diagram of another exemplary embodiment of an electrochemical hydrogen pumping cell 200 as compared to that of FIG. 1. As shown, the cell 200 includes a metal, e.g., a working electrode 202, having hydrogen particles 203 interspersed therethrough. A potential is applied between the working electrode 202 and a counter electrode 206 as shown, with a catalyst 208 being applied to the surface of the working electrode 202 to pump hydrogen ion out of the working electrode 202 into the electrolyte 204 in which the working electrode 202 and the counter electrode 206 are exposed.

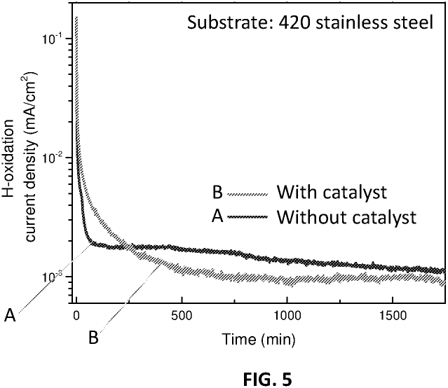

FIG. 5 illustrates hydrogen pumping current density of martensitic stainless steel with and without catalyst. As shown, the martensitic stainless steel with catalyst represented by a line (B) has a higher oxidation current at the initial stage compared to its counterpart without a catalyst, represented by a line (A). This indicates faster hydrogen removal from the specimen by the catalyst. Moreover, because the total hydrogen content is the same in both cases, the hydrogen oxidation current in the specimen with the catalyst becomes lower than that of the specimen without the catalyst after removal of large amounts of hydrogen in a short time at the initial stage.

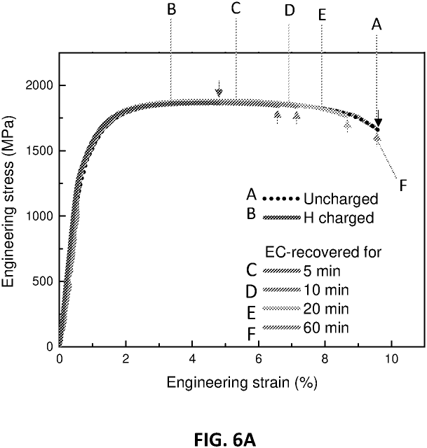

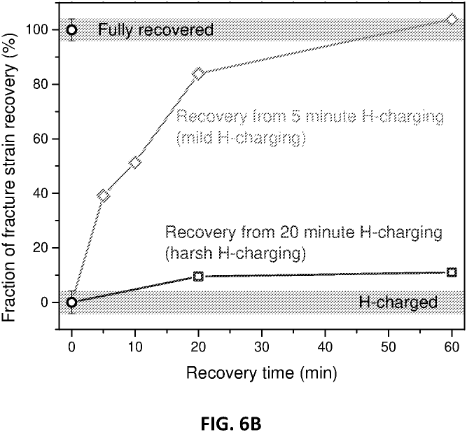

Similar results were observed in the recovery of martensitic stainless steel from hydrogen embrittlement. FIGS. 6A-6B illustrate tensile test results of martensitic stainless steel sheets after hydrogen charging and recovery for various amounts of time. As shown, samples that are hydrogen charged in a 5 volume % sulfuric acid solution containing 5 g/L ammonium thiocyanate for 5 minutes experience substantial recovery of fracture strain by electrochemical pumping, and the amount of recovery increases by increasing electrochemical pumping time. Electrochemical pumping for 60 minutes (F) can lead to complete recovery that resembles the original uncharged state (A).

FIG. 6B illustrates a comparison of the recovered fraction of fracture strain from 5 minute hydrogen charging, which in at least some contexts may be referred to as mild H-charging, and 20 minute charging, which in at least some contexts may be referred to as harsh H-charging. As shown, the fraction of recovery from hydrogen embrittlement can depend on the amount of hydrogen charging and time. For example, full recovery can occur after approximately 60 minutes when hydrogen charging occurs for five minutes, while full recovery from twenty minutes of hydrogen charging is unlikely to occur. As shown, after twenty minutes of hydrogen charging, only approximately 10% recovered fraction of fracture strain is observed during the same time that full recovery from five minutes of hydrogen charging occurs. Thus, longer charging times can result in it being more difficult to achieve a suitable fraction of fracture strain recovery.

Recovery of the material from hydrogen embrittlement can occur without thermal treatment. Thermal, or heat, treatment includes raising the temperature, or baking, the material at elevated temperatures and/or pressures to expel hydrogen therefrom while measuring fracture time to ensure that the material does not fracture. Conventionally, thermally-assisted desorption can be an effective strategy to remove hydrogen from even the deepest microstructural traps. In fact, this is the basis of thermal desorption spectroscopy, which is widely used for analyzing the amount of hydrogen trapped inside materials. Yet, a person skilled in the art will recognize that several practical challenges associated with heat treatments render this strategy difficult to apply in engineering practice. For example, thermal treatment requires disassembly of parts out of an in-service state. This downtime can be problematic as it decreases efficiency and increases costs, making it impractical for large-scale, industrial processes. Further, a person skilled in the art will recognize that in the event of hydride formation on the material, recovery of the material by the presently disclosed methods may not be possible due to permanent deformation of the material.

Examples of the above-described embodiments can include the following:

1. A method of regulating hydrogen transport from a material, comprising:
exposing a material to an electrolyte, the material being in an unbrittled state from an original state due to a concentration of atomic hydrogen contained therein;
depositing a catalyst onto the material;
disposing a counter electrode in the electrolyte; and
applying a potential between the material and the counter electrode,
wherein the potential creates a gradient across the material to accelerate diffusion of the hydrogen to a surface of the material by promoting an oxidation reaction of the atomic hydrogen contained within the material.

2. The method of claim 1, wherein adjusting the potential accelerates a rate of atomic hydrogen oxidation to hydrogen ion.

3. The method of any of claim 1 or claim 2, wherein the applied potential is approximately in a range from about 0 V to about +100 V versus reversible hydrogen electrode potential.

4. The method of any of claims 1 to 3, wherein the applied potential is lower than a passivation threshold potential of the material.

5. The method of any of claims 1 to 4, wherein the oxidation reaction occurs at room temperature.

6. The method of any of claims 1 to 5, wherein the material is one of steel and stainless steel.

7. The method of any of claims 1 to 6, further comprising adjusting the potential to change a rate of diffusion of the hydrogen to the surface of the material.

8. The method of any of claims 1 to 7, wherein the material recovers over 90% of ultimate tensile strength and fracture strain as hydrogen diffuses towards the surface thereof.

9. The method of any of claims 1 to 8, wherein diffusion of hydrogen occurs either without thermal treatment or with heating of up to 200° C.

10. The method of any of claims 1 to 9, wherein the catalyst comprises one or more of palladium, platinum, nickel, titanium, molybdenum disulfide or lanthanum.

11. The method of any of claims 1 to 10, wherein the catalyst is applied onto a surface of the material while the material is immersed in the electrolyte to bring the hydrogen to the surface of the material.

12. The method of any of claims 1 to 11, wherein the oxidation reaction reduces the concentration of the hydrogen contained in the material.

13. A system for recovering materials from hydrogen embrittlement, comprising:
an electrolyte;
a material having atomic hydrogen therein, the material being disposed in the electrolyte;
a catalyst applied to the surface of the material; and
an electrode disposed in the electrolyte, the electrode being in communication with the material, the electrode being configured to apply a potential across the material that creates a gradient across the material to accelerate diffusion of the hydrogen to a surface of the material, thereby promoting an oxidation reaction of the atomic hydrogen contained within the material.

14. The system of claim 13, the catalyst comprises one or more of palladium, platinum, nickel, titanium, molybdenum disulfide or lanthanum.

15. The system of any of claim 13 or claim 14, wherein the electrode comprises one or more of platinum, palladium, nickel, titanium, molybdenum or their alloys.

16. The system of any of claims 13 to 15, wherein the material comprises one or more of iron, nickel, cobalt, aluminum, magnesium, titanium, zirconium, steel, stainless steel, alloys thereof, or superalloys thereof.

17. The system of any of claims 13 to 17, wherein the system is configured to operate either without the use of thermal treatment or with heating of up to 200° C.

18. The system of any of claims 13 to 18, wherein the system is configured to recover the material to its original state as hydrogen diffuses towards the surface of the material.

One skilled in the art will appreciate further features and advantages of the disclosures based on the provided for descriptions and embodiments. Accordingly, the inventions are not to be limited by what has been particularly shown and described. All publications and references cited herein are expressly incorporated herein by reference in their entirety.

What is claimed is:

1. A method of regulating hydrogen transport from a material, comprising:
exposing a material to an electrolyte, the material being in an embrittled state from an original state due to a concentration of atomic hydrogen contained therein;
depositing a catalyst onto the material;
disposing a counter electrode in the electrolyte; and
applying a potential between the material and the counter electrode,
wherein the potential creates a gradient across the material to accelerate diffusion of the hydrogen to a surface of the material by promoting an oxidation reaction of the atomic hydrogen contained within the material.

2. The method of claim 1, wherein adjusting the potential accelerates a rate of atomic hydrogen oxidation to hydrogen ion.

3. The method of claim 1, wherein the applied potential is approximately in a range from about 0 V to about +100 V versus reversible hydrogen electrode potential.

4. The method of claim 1, wherein the applied potential is lower than a passivation threshold potential of the material.

5. The method of claim 1, wherein the oxidation reaction occurs at room temperature.

6. The method of claim 1, wherein the material is one of steel and stainless steel.

7. The method of claim 1, further comprising adjusting the potential to change a rate of diffusion of the hydrogen to the surface of the material.

8. The method of claim 1, wherein the material recovers over 90% of ultimate tensile strength and fracture strain as hydrogen diffuses towards the surface thereof.

9. The method of claim 1, wherein diffusion of hydrogen occurs either without thermal treatment or with heating of up to 200° C.

10. The method of claim 1, wherein the catalyst comprises one or more of palladium, platinum, nickel, titanium, molybdenum disulfide or lanthanum.

11. The method of claim 1, wherein the catalyst is applied onto a surface of the material while the material is immersed in the electrolyte to bring the hydrogen to the surface of the material.

12. The method of claim 1, wherein the oxidation reaction reduces the concentration of the hydrogen contained in the material.

13. A system for recovering materials from hydrogen embrittlement, comprising:
an electrolyte;
a material having atomic hydrogen therein, the material being disposed in the electrolyte;
a catalyst applied to the surface of the material; and
an electrode disposed in the electrolyte, the electrode being in communication with the material, the electrode being configured to apply a potential across the material that creates a gradient across the material to accelerate diffusion of the hydrogen to a surface of the material, thereby promoting an oxidation reaction of the atomic hydrogen contained within the material.

14. The system of claim 13, the catalyst comprises one or more of palladium, platinum, nickel, titanium, molybdenum disulfide or lanthanum.

15. The system of claim 13, wherein the electrode comprises one or more of platinum, palladium, nickel, titanium, molybdenum or their alloys.

16. The system of claim 13, wherein the material comprises one or more of iron, nickel, cobalt, aluminum, magnesium, titanium, zirconium, steel, stainless steel, alloys thereof, or superalloys thereof.

17. The system of claim 13, wherein the system is configured to operate either without the use of thermal treatment or with heating of up to 200° C.

18. The system of claim 13, wherein the system is configured to recover the material to its original state as hydrogen diffuses towards the surface of the material.
